(19) United States
(12) Patent Application Publication
(10) Pub. No.: US 2026/0315324 A1
(43) Pub. Date: Oct. 15, 2026

(54) A MEDICAL CONTAINER

(71) Applicant: INJECTO GROUP A/S, Hellerup (DK)

(72) Inventor: Mikael HETTING, Hellerup (DK)

(21) Appl. No.: 19/485,214

(22) PCT Filed: May 17, 2024
(86) PCT No.: PCT/DK2024/050117

§ 371 Date: Nov. 17, 2025

(30) Foreign Application Priority Data
May 17, 2023 (DK) PA 2023 70241
Jun. 2, 2023 (DK) PA 2023 00503

(51) Int. Cl. A61J 1/14

(52) U.S. Cl. CPC A61J 1/1406; A61J 1/1468

(57) ABSTRACT

The present invention relates to a medical container (1) for storing a liquid medicament. The medical container comprises a cylinder (10) with an inlet opening (13) into which a stopper (3) prepared from solidifying a thermoplastic elastomer (TPE) from a molten form and having been exposed to a temperature below the glass transition temperature (Tg) of the thermoplastic elastomer is inserted. The present invention also relates to a method of manufacturing the medical container.

### FIELD OF THE INVENTION

The present invention relates to a medical container for storing a liquid medicament. The medical container comprises a cylinder and a stopper inserted into the cylinder. The medical container allows storage of sensitive drugs at extreme temperature while retaining closure integrity. The present invention also relates to a method of manufacturing the medical container.

### BACKGROUND

In the world of pharmaceutical drugs, biologic formulations are becoming increasingly complex and sensitive, which characteristics call for certain precautions when it comes to packaging of such parenteral formulations. Biologics are comprised of complex combinations of proteins, peptides, amino acids, nucleic acids or sugars that are produced through a variety of biotechnological processes. Cooling is generally required to retain chemical stabilities, e.g. formation of potentially harmful protein aggregates, and at all time contamination with bacteria must be avoided. In contrast, most small molecules can be stored at ambient temperatures.

For many years and still, cold chain storage is regulated according to ICH guidelines, and in most instances injectable drugs are stored at either room temperature or more commonly between 2 and 8 °C, a temperature range which is utilized within a wide range of formulations.

During the last decade the development of especially temperature sensitive innovative biologic formulations has increased and requires the use of cold storage under freezing conditions, such formulations within the large molecule segment, namely biologic drugs, especially mRNA formulations, cell therapies, but also gene therapies. For example. in response to the COVID-19 pandemic, vaccines based on mRNA became available and were used at large scale but due to the low stability of mRNA, storage at extremely low temperature, e.g. below −80 °C, was now necessary.

Drugs and vaccines can be stored in vials from which injection doses are prepared when needed or in prefilled syringes (PFS) that are provided in a ready-to-use format. Regardless whether a drug or vaccine is stored in a vial or in a PFS, the requirements regarding the storage temperature are the same. Both vials and PFSs include a container and a stopper, and the stopper is normally prepared from an elastomeric material intended to ensure the integrity of the container. The container may be made from glass or a hard polymer.

The vial stopper is made from an elastomeric material, and rubbers have seen widespread use, although thermoplastic elastomers (TPE) have also been suggested, see e.g. WO 00/73163 and EP 0174032. TPEs have also been used for stoppers for syringes, see e.g. WO 2014/194918, WO 2017/157396, and WO 2019/185101.

Relevant materials, such as rubbers or elastomers, for a stopper for a vial or syringe are elastomeric at ambient temperature and also generally have a temperature below or at which, the material becomes brittle. This temperature is referred to as the glass transition temperature (T_{g}). The required freezing conditions include temperatures below the T_{g} of the elastomeric closure material used in vials and PFSs, and in some cases even cryogenic temperature levels of down to −196 °C or even lower.

Moreover, materials generally shrink or expand depending on temperature, and both the materials for the container and the stopper can be described by a coefficient of thermal expansion (CTE). Thus, upon cooling both the container and the stopper will shrink in accordance with their respective CTE.

The combination of the shrinkage of the materials and the transition to the brittle phase of the stopper material creates a challenge for storing drugs and vaccines at extremely low temperatures, which may be reflected in i.a. an increased risk of microbial ingress into the container. Such freezing temperatures therefore require equally compliant and capable packaging components, and it is crucial to ensure that any contamination such as microbial ingress must be avoided prior to freezing, during freezing, and ultimately during subsequent thawing.

For a number of reasons, the currently available elastomeric closure solutions for medical containers are not optimized for significantly low freezing temperatures.

Presently, the majority of container closures such as elastomeric plungers for PFS and vial stoppers are made from butyl rubber, and the butyl rubber may further be coated with perfluorinated compounds, such as polytetrafluoroethylene (PTFE), ethylene-tetrafluoroethylene copolymer (ETFE) or similar coatings. These coatings are commonly used to prevent unwanted rubber leachables from contaminating the formulation and for PFSs may also provide lubrication. However, the highly different material characteristics between butyl rubber and perfluorinated surface coatings pose challenges for maintaining the highly important container closure integrity (CCI) in medical containers during freezing temperatures below the elastomeric closures' T_{g}, and ultimately lack precautions against microbial ingress and hence pose a risk for contamination of the medical formulation. In the following the expressions elastomeric closure, elastomer closure, PFS plunger, plunger, vial stopper and stopper may be used interchangeably.

For example, butyl rubber has a T_{g} around −60 °C while a surrounding PTFE coating has a significantly lower T_{g}, where the coating at temperatures as low as −200 °C shows little to no brittleness. This significant material difference results in inappropriate closure behaviour, where the butyl rubber will tend to shrink more than the PTFE coating, which may not shrink at all depending on freezing degree. Moreover, butyl rubber PFS plungers and vial stoppers generally shrink by about 4.5% thus causing an excess reduction of the stopper's transverse diameter during freezing, so that the risk of leakage is imminent. These inappropriate differences in material and their behaviour during deep freeze of a medical container of down to −80 °C to −90 °C or lower will imply different material response from the combined closure materials for a coated butyl rubber closure, which can cause local folding of the coating thereby breaching the sealing between closure and medical container wall partly or fully, and hence a breach of the CCI. The folding of the coating will ultimately allow for microbial ingress and contamination of the medical formulation.

Aseptic Technologies SA (Gembloux, Belgium) provides a vial technology known as AT-Closed Vial where a vial is closed using a stopper prepared from a TPE. Aseptic's approach includes piercing the TPE stopper to fill the vial and then using laser welding to re-seal the stopper. The technology involves freezing the vials below the T_{g} and Aseptic has observed that TPEs are particularly suited materials for use for a stopper for a vial to be stored at extremely low temperatures below the T_{g} of the TPE, as container integrity is retained due to the TPE stopper. The technology is described by Aseptic Technologies in Container Closure Integrity at Cryogenic Temperatures: How the AT-Closed Vial® ensures safe cryopreservation of novel therapies. 2020, available from Aseptic Technologies SA's download centre (www.aseptictech.com/en/download-center). TPEs designed for absorbing laser light are disclosed in WO 2004/018317, WO 2005/014419, WO 2005/005128, and WO 2006/122757; see also WO 2007/020366.

It is an object of the present invention to provide a medical container allowing storage at extreme temperatures. It is a further object that the medical container can be used at ambient temperature.

### SUMMARY

The present invention relates to a medical container for storing a liquid medicament, the medical container comprising:
a cylinder extending along a longitudinal axis, the cylinder having an inner wall, an inlet opening at an inlet end and a bottom end opposite the inlet end, which inlet opening defines a transverse diameter,
a stopper inserted into the cylinder from via the inlet opening, the stopper having a stopper body and a sealing surface surrounding the stopper body and having an outer diameter, which is larger than the transverse diameter, so that the sealing surface seals an annular gap between the inner wall and the stopper body when the stopper is inserted into the cylinder, the stopper being made from a thermoplastic elastomer (TPE), and the stopper having been exposed to a temperature below the glass transition temperature (T_{g}) of the thermoplastic elastomer, and
a liquid medicament in the cylinder between the bottom end and the stopper.

The medical container comprises a cylinder, and the cylinder has an inlet end and a bottom end opposite the inlet end. The medical container has a “bottom end”, but the term bottom end is not intended to imply any specific orientation of the medical container, merely that the bottom end is opposite the inlet end. The bottom end may also be referred to as a closure end, and the two terms may be used interchangeably. The cylinder may be made from any material commonly used for medical containers, such as vials and syringes. For example, the cylinder may be made from glass, e.g. borosilicate glass, or a polymer, e.g. cyclic olefin copolymer (COC), e.g. TOPAS polymers (supplied by TOPAS Advanced Polymers GmbH), cyclic olefin polymer (COP), e.g. Zeonor, polypropylene (PP), polyethylene (PE), or polystyrene. Borosilicate glass generally has superior barrier characteristics compared to plastics. COC and COP polymers are advantageous due to their excellent barrier characteristics and thus accommodate the need for long-term storage of pharmaceutical agents.

The medical container comprises a stopper. In the present context, the word “stopper” is used regardless of the type of medical container, e.g. if the medical container is a syringe, e.g. a prefilled syringe (PFS), or a vial. However, depending on the specific use of the stopper and the corresponding medical container, the stopper may also be referred to as a “piston”, e.g. when the medical container is a syringe, or a “closure” when the medical container is a vial. In the present context, regardless whether the medical container is a vial, a PFS or another type of medical container, the stopper is considered to have an “actuating surface” facing the ambient exterior of the medical container after insertion of the stopper into the medical container, e.g. into the cylinder, and the surface of the stopper opposite the actuating surface is referred to as the “inner surface” of the stopper. However further in the present context, the terms “actuating surface” and “inner surface” are also used in the description of the stopper without reference to its insertion into the medical container. In general, the stopper is considered to have a length between the actuating surface and the inner surface; the length may also be referred to as the “stopper length”.

The stopper has a stopper body and sealing surface surrounding the stopper body. In general, any part of the stopper abutting the inner wall of the cylinder to thereby seal an annular gap between the inner wall and the stopper body when the stopper is inserted into the cylinder, is considered the sealing surface. For example, the sealing surface may be the surface of the stopper body or a section of the stopper body, a section of the stopper body e.g. along the length of the stopper body, abutting the inner wall of the cylinder after insertion of the stopper into the cylinder, and the sealing surface, e.g. the stopper body, may have an outer diameter that is 0.5% to 10%, e.g. 1% to 9%, 2% to 8%, 3% to 7% or 4% to 6%, larger than the transverse diameter, when the stopper is in a relaxed state. In a specific example, the outer diameter is 2% to 5% larger than the transverse diameter. In an example, the stopper has a deformable sealing element, in particular a convex deformable sealing element, and the sealing surface is any section of the deformable sealing element abutting the inner wall of the cylinder. When the stopper has a deformable sealing element, in particular a convex deformable sealing element, the deformable sealing element also has an outer diameter, and the outer diameter of the deformable sealing element is larger than the outer diameter of the stopper body. For example, the outer diameter of the stopper body may be smaller than the transverse diameter, and the outer diameter of the deformable sealing element may be 0.5% to 10%, e.g. 1% to 9%, 2% to 8%, 3% to 7% or 4% to 6%, larger than the transverse diameter, when the stopper is in a relaxed state. In a specific example, the outer diameter is 2% to 5% larger than the transverse diameter., when the stopper and the deformable sealing element are in a relaxed state. The term “outer diameter” may refer to the diameter of the deformable sealing element or the diameter of the stopper body when the stopper does not comprise a deformable sealing element as will be clear from the context. In an example, the medical container is a PFS, and the stopper has a convex deformable sealing element having an outer diameter that is 1% to 8%, 2% to 7% or 3% to 6%, larger than the transverse diameter, when the stopper is in a relaxed state. In another example, the medical container is a vial, and the stopper has a convex deformable sealing element having an outer diameter that is 1% to 8%, 2% to 7% or 3% to 6%, larger than the transverse diameter, when the stopper is in a relaxed state.

The cylinder generally has an inner wall and an outer wall and extends along a longitudinal axis. The cylinder also has an inlet opening at an inlet end and a bottom end opposite the inlet end. In general, the inlet opening extends from the inlet end into the cylinder. The cylinder and the inlet opening each have a cross-sectional shape, and the cross-sectional shape and size of the inlet opening may be the same as the cross-sectional shape and size of the cylinder. When the inlet opening has a cross-sectional shape and/or a cross-sectional dimension that is different from the cross-sectional shape and/or the cross-sectional dimension, as appropriate, of the cylinder, the cylinder is considered to define an inlet section, which has the transverse diameter, and a vessel section between the inlet section and the bottom end, which vessel section has a cross-sectional shape and/or a cross-sectional dimension that is/are different from the cross-sectional shape and/or the cross-sectional dimension of the inlet section. When the cylinder has an inlet section, the inlet opening is located at the inlet section. In an example, the inlet opening and the cylinder have the same cross-sectional shape and the same cross-sectional dimension, and the medical container is a PFS. In another example, the inlet opening and the cylinder have the same cross-sectional shape and the same cross-sectional dimension, and the medical container is a vial. In a further example, the inlet opening and the cylinder have at least a different cross-sectional dimension and optionally also a different cross-sectional shape, and the medical container is a vial. When the medical container is a vial, the vial may have any size in compliance with ISO standard 8362. Alternatively, the vial may have any size in compliance with the standard YBB00302002.

The cross-sectional shape of the cylinder, the inlet opening, and the inlet section, when relevant, may be chosen freely. When a cross-sectional shape is different from a circular cross-section, the largest cross-sectional dimension of the shape may be referred to as a “diameter” in the present context. It is preferred that the cylinder, the inlet opening, and the inlet section, when relevant, have a circular cross-section. It is also contemplated that the cross-sections may be oval, elliptical, polygonal, etc. When medical container is a PFS, the transverse diameter, e.g. the inner diameter, may have any value conventionally used with syringes. For example, the medical container may be a PFS, and the cylinder may have a transverse diameter in the range of 2 mm to 12 mm, such as 4.65 mm, 6.35 mm, 8.65 mm or 11.85 mm, although it may have larger values according to the invention.

The present medical container is suited for storing a liquid medicament. The liquid medicament is generally contained in the cylinder in the space between the bottom end and the stopper inserted into the inlet opening. The space between the bottom end and the stopper may also be referred to as the inner space of the cylinder. In the present context, the stopper has a surface, e.g. an inner surface, facing the medical liquid and a surface facing, e.g. an actuating surface, away from the medical liquid, e.g. the ambient exterior of the medical container.

The stopper is made from a TPE. Specifically, the stopper may have been made by solidifying the TPE from a molten form, e.g. to the intended form of the stopper. Any manufacturing method where a molten thermoplastic polymer can be solidified, especially to its final form, can be used in the manufacture of the stopper of the disclosure. For example, the stopper may be injection moulded from a TPE. In general, when any part of the stopper, e.g. the deformable sealing element, is not deformed, e.g. when the stopper is not inserted into a medical container, the corresponding part, e.g. the deformable sealing element, is considered to be in a “relaxed state”, i.e. in a state without deformation. In the context of the invention, the “deformable sealing element” may describe any section of the stopper, which has a diameter larger than the diameter of the stopper body so that the deformable sealing element surrounds the stopper body. In the context of the invention, the term “diameter” does not imply that the corresponding element, e.g. the stopper body or the deformable sealing element, must have a circular cross-section, i.e. the cross-section in the lateral plane of the stopper, and any cross-sectional shape as desired may be used for the stopper body and/or the deformable sealing. For example, the cross-section may be polygonal, e.g. triangular, square, pentagonal, hexagonal, etc., and the term diameter will in this case refer to a cross-sectional dimension, e.g. the largest cross-sectional dimension for the corresponding cross-sectional shape. A polygonal cross-section is not limited to polygons having equal angles and side lengths, i.e. regular polygons, and likewise the cross-section may also be elliptical. The cross-sectional shape of the inlet opening, and the inlet section when relevant, and optionally also the vessel section of the cylinder, corresponds to the cross-sectional shape of the deformable sealing element. When the stopper has deformable sealing element, the stopper body generally does not interact with the inner wall of the inlet opening, the inlet section and the vessel section of the cylinder, when relevant, and the cross-sectional shape of the stopper body can be chosen freely, regardless of the cross-sectional shape of the deformable sealing element.

The cylinder, and thereby also the medical container, has an inlet opening, and optionally also an inlet section, at the inlet end, and the stopper is inserted into the cylinder via the inlet opening. Thus, the stopper has a stopper body and a sealing surface, and optionally also a deformable sealing element, surrounding the stopper body and having an outer diameter, which is larger than the transverse diameter, so that the sealing surface, or the deformable sealing element when present, seals an annular gap between the inner wall and the stopper body when the stopper is inserted into the cylinder.

In an example, the stopper has a convex deformable sealing element. In particular, the stopper may have a convex deformable sealing element on the stopper body. For example, the stopper body may have a diameter smaller than the transverse diameter, and the deformable sealing element has a diameter larger than the transverse diameter so that the deformable sealing element provides the sealing surface. In this context, the term “convex” means that a straight line between any two points within the deformable sealing element does not cross the surface of the deformable sealing element. Any convex shape is contemplated, but the deformable sealing element preferably has a point, e.g. a point in an axial plane of the stopper, representing the maximal extension from the centre axis of the stopper. When the deformable sealing element has a convex surface the force exerted via the deformable sealing element on the inner wall of the container will be maximised, since deformation of the deformable sealing element in a direction of the longitudinal axis of the cylinder is minimised. The contact may for example be at an abutting interface between the deformable sealing element and the inner wall of the cylinder. It is preferred that the extent of the contact between the deformable sealing element and the inner wall of the cylinder of an injector into which the stopper has been inserted is as small as possible. In an example, the deformable sealing element has an outer diameter that is 1.5% to 10%, e.g. 2% to 5%, larger than the transverse diameter, when the deformable sealing element is in a relaxed state. A convex deformable sealing element on a stopper injection moulded from a TPE is especially advantageous due to the lower tolerances provided by the injection moulding compared to technologies such as vulcanisation that is commonly used in the manufacture of traditional rubber pistons. When the medical container is a PFS, the stopper can be injection moulded to a size providing CCI and at the same time having a low break loose force (BLF). When the medical container is a vial, the stopper can be injection moulded to sufficiently large size ensuring CCI compliance without the stopper being too large for insertion into the inlet opening of the cylinder of the medical container. For example, when the stopper has a deformable sealing element, the outer surface may be in the range of 2% to 7% larger than the transverse diameter, and thereby CCI can be ensured without the need of a crimp cap. In an example, the stopper has a deformable sealing element, and the medical container does not include a crimp cap, in particular, the medical container may not include an aluminium crimp cap.

The stopper of the medical container is prepared from solidifying a TPE from a molten form. For example, the stopper may be injection moulded from a TPE. In general terms, a thermoplastic polymer has a solid phase, in particular the TPE is solid at ambient and lower temperature, and a melting point allowing that the polymer is molten by increasing the temperature and resolidified by again reducing the temperature and thereby regain the solid form or state it had before melting. This allows that thermoplastic polymer can be injection moulded. The stopper may be injection moulded from a TPE, although it is also contemplated that other methods of preparation may be used for the stopper. For example, the stopper may be compression moulded. For the same reasons that injection moulding is useful for treating a TPE, the stopper, being of a TPE, may also be produced by extrusion. Thus, in an example, the stopper has been prepared using extrusion.

The stopper has been exposed to a temperature below the T_{g} of the TPE. In general terms, a T_{g} can be defined for polymeric materials, and “hard” polymers are normally used below their T_{g}, whereas “soft” polymers, e.g. elastomers, are normally used above their T_{g}. Upon cooling a polymer below its T_{g}, brittleness can be observed for the polymer, and the identification of a T_{g} value for a specific polymer, including a TPE, is within the knowledge of the skilled person. TPEs relevant for the present disclosure commonly have T_{g} values in the range of −50 °C to −70 °C. For example, Evoprene R9970 has a T_{g} of about −67 °C. Thereby, when a PFS or vial of the present disclosure containing a sensitive drug, e.g. an mRNA based drug, is brought to a typical storage temperature of −80 °C or below, the PFS or vial is cooled below the T_{g} of the TPE of the stopper of the medical container. The stopper has been exposed to a temperature below the T_{g} of the TPE. However, this exposure may alternatively be expressed with reference to a temperature without reference to the T_{g}. For example, in another wording the stopper has been exposed to a temperature at or below −50 °C, such as −60 °C, −70 °C or −80 °C. The duration of the exposure to temperature below the T_{g} of the TPE, e.g. at or below −50 °C, such as −60 °C, −70 °C or −80 °C, is not important. In general, the medical container is cooled to this temperature to store the medical container with the liquid medicament, e.g. for a period of several weeks or months, but otherwise the effect of the cooling of the TPE to below its T_{g} is considered to occur instantaneously, e.g. after 10 seconds.

TPEs represent a special type of thermoplastic materials, which in their solid form are elastomers, so that they exhibit reversible, e.g. instantaneously reversible, deformation. Different types of TPEs exist and a specific type of TPE is known as styrene based TPEs. Styrene based TPEs contain block copolymers of polystyrene and another polymer component, where the styrene part is generally hard and the other component is generally soft, and where the soft component provides elasticity. The block copolymer may contain blocks of two or more, e.g. two, three or four, polymers, and the same polymer may be included in different blocks, as will be reflected in the name of the polymer. Styrene based block copolymers are generally abbreviated “SBC” in the present context. Exemplary non-styrene polymer components of an SBC are ethylene, butylene and butadiene. By having the hard, e.g. the styrene part, and the soft, e.g. the ethylene, butylene or butadiene party, the SBC obtains a thermoplastic character while also having an elastic character for the SBC in its solid form. Specific SBSs include hydrogenated—H-SBC or non-hydrogenated SBCs. Relevant styrene based TPEs include styrene butadiene styrene (SBS), styrene ethylene butadiene styrene (SEBS), styrene ethylene butylene styrene (SEBS), styrene butadiene (styrene-butadiene rubber, or SBR), styrene isobutylene styrene (SIBS), styrene isoprene styrene (SIS), styrene ethylene propylene (SEP) or styrene ethylene propylene styrene (SEPS), and methacrylate butadiene styrene (MBS). In addition to the styrene block copolymer, a styrene based TPE may also include another polymer, e.g. a polyolefin such as polyethylene or polypropylene, and other components, e.g. processing aids, oil, fillers, stabilisers. Various TPEs are known under the trade names Styroflex (INEOS) and Styrolux (BASF Corporation of Wyandotte, Mich., USA), Septon Q, Septon V, and Hybar (Kuraray America, Inc., Houston, Texas, USA), Maxelast TPE (Nantong Polymax Elastomer Technology Co., Ltd), GLOBALPRENE Polymers (LCY Chemical Corporation), Elexar and Monprene (Teknor Apex Company), Elastocon series (Elastocon TPE Technologies, Inc.), TPR (Washington Penn), Evoprene (Alpha Gary), Versaflex, OnFlex, Versalloy, Versollan, Dynaflex (GLS Thermoplastic Elastomers), Sevrene (Vichem Corporation), Vector (Dexco Polymers LP), Calprene and Solprene (Dynasol), Multiflex TEA and Multiflex TPE (Multibase, Inc.), Europrene Sol T (Polimeri Europe), Sunprene (PolyOne), Leostomer (Riken Technos Corporation), RTP 2700 and 6000 series (RTP), Invision (A. Schulman), Dryflex (VTC Elastotechnik), Quintac (Zeon), Megol and Raplan (API spa), Asaprene and Tufprene (Asahi Kasei), Lifoflex (Miiller Kunststoffe, Germany), Thermolast (Kraiburg TPE GmbH & Co. KG, Waldkraiberg, Germany) or Kraton, for example Kraton D, Kraton G or Kraton FG (Kraton Polymers, Houston, Texas, USA).

It is preferred that the TPE of the stopper includes another polymer, e.g. a polyolefin such as polyethylene or polypropylene, and the TPE may further comprise other components. However, it is preferred that the other polymer, and also the other components, do not comprise a perfluorinated compound. In the present context, a perfluorinated compound is an organic molecule where one or more carbon atoms carry only F atoms in addition to the links, e.g. single bonds, to other carbon atoms. Thus, it is preferred that the TPE does not comprise polytetrafluoroethylene (PTFE) and ethylene-tetrafluoroethylene copolymer (ETFE). It is further preferred that the TPE does not contain a polymer, e.g. a polyolefin polymer, having a melting point above 170 °C or above 150 °C. It is especially preferred that the stopper does not include a perfluorinated compound on the surface of the stopper, e.g. it is preferred that the stopper is not coated with a perfluorinated compound, e.g. PTFE or ETFE.

In general, the stopper is homogeneous and composed of the same material throughout the volume of the stopper, including the deformable sealing element and the stopper body. The stopper preferably does not contain a coating, e.g. a coating of PTFE or ETFE, although it is also contemplated that the stopper may be coated with a material free from fluorine atoms, especially a perfluorinated compound. For example, the stopper may be coated from a gas phase, e.g. using vapour deposition, such as atomic layer deposition, or the stopper may be coated from a liquid, e.g. using liquid-phase deposition. The homogeneity is relevant regardless of the presence of additional components in the TPE. For example, the TPE may be an SBC, or the TPE may be an SPC with additional components. The additional component may comprise or be another polymer than the SBC, e.g. a polyolefin, such as polyethylene and/or polypropylene, and an oil. The TPE may also comprise a filler and other auxiliary components. In the present context, the term “TPE” refers to the material of the stopper. Being elastic, TPEs are commonly classified according to the hardness as measured according to the Shore scale, especially the Shore A scale. For example, the TPE may have a Shore A hardness in the range of 30 to 90, e.g. in the range of 40 to 75, e.g. 40 to 70, 45 to 65, or 50 to 60, when the medical container is a vial, and in the range of 60 to 90, e.g. 70 to 80, when the medical container is a PFS. The “Shore hardness” may also be referred to as the “Shore durometer” and the terms may be used interchangeably. However, it should be noted that the Shore A durometer is only one of many ways to characterise the material properties of the chosen material, and that other tests may also be employed to characterise the material. Measurement of the Shore A hardness is well-known to the skilled person and in particular the Shore A hardness is generally recorded according to the ISO 868 standard. The hardness of a TPE is generally influenced by the composition of the TPE, and for example, the TPE may contain an oil to lower the Shore A hardness. The percentage of oil in the TPE generally varies with the shore hardness for a given embodiment of the TPE, and a Shore A value of 50 typically includes an oil percentage by weight in the range of 50 to 55, whereas a Shore A value of 72 typically includes an oil percentage in the range 30 to 40. Thus, in an example, the stopper is made from a TPE, comprising a block copolymer, e.g. an SBC, providing thermoplasticity, and an oil, e.g. a process oil or a mineral oil. In a specific example, the stopper is made from an SBC-based TPE, e.g. SEBS or SBS, comprising oil in the range of 50 weight % to 55% weight % and having a Shore A hardness in the range of 45 to 55. For this stopper the medical container is preferably a vial. In another specific example, the stopper is made from an SBC-based TPE, e.g. SEBS or SBS, comprising oil in the range of 30 weight % to 40% weight % and having a Shore A hardness in the range of 65 to 75. For this stopper the medical container is preferably a PFS.

The TPE may contain a polymer, e.g. a polyolefin such as polyethylene or polypropylene, i.e. a polymer different from the copolymer, e.g. the SBC, and the TPE may further comprise other components. The other components may include a slip agent. In general terms, a slip agent can be used to avoid material degradation during compounding of TPE and to ease the release of a polymer from the mould employed in an injection moulding, although slip agents may also provide a lubricious effect where the surface of a TPE abuts the surface of another material, e.g. glass or a polymer. Slip agents are typically derived from waxes and/or fatty acids, e.g. polyethylene wax, paraffin wax, wax esters, metal stearates, long-chain fatty acids, long-chain fatty acid amides (e.g. compounds known as oleamide and erucamide) and salts thereof, and these may be used as slip agents. Specific slip agents are salts of a divalent metal and stearate, e.g. magnesium stearate, calcium stearate or zinc stearate. In an example, the TPE comprises a slip agent, e.g. in the TPE or on the surface of the TPE. In another example, the TPE does not comprise a slip agent. In an example, the TPE does not contain a slip agent. In a specific example, the surface of the stopper, e.g. the surface of the TPE, does not contain a slip agent In a specific example, the TPE does not comprise a slip agent based on a salt of a divalent metal ion and stearate. In particular, salts of a divalent metal ion and stearate are generally considered unwanted in substances in contact with medicines, especially liquid medicines, and therefore salts of a divalent metal ion and stearate should not be included in a stopper for a medical container, such as a vial or a PFS. Despite providing a lubricious effect, slip agents are not necessary in a PFS. Thus, in an example, the medical container is a PFS, and the TPE does not comprise a slip agent, and the stopper does not contain any external lubrication, especially not a silicone lubricant. Likewise, it is preferred that the stopper does not include a perfluorinated compound, especially on the surface of the stopper.

The TPE may also contain a filler. Fillers are typically particles with appropriate properties, and in general a filler may affect the physical, mechanical, and/or optical properties of a TPE. The filler may for example be a pigment to provide colour or increase the opacity of a TPE. The filler may for example be an inorganic particle, e.g. an oxide of metals or other elements, e.g. aluminium and/or silicon. The filler may for example be kaolin. In general terms, a filler increases the hardness, e.g. the Shore A hardness, of a TPE, and the higher the amount of the filler, the harder the TPE. Thus, the amount of filler may be selected from the intended hardness together with the content of oil in the TPE. The filler may also reduce material permeation with increased filler amount. When present, the filler, e.g. kaolin, may constitute up to 20 weight % of the TPE. For example, the TPE may contain a filler, e.g. kaolin, in the range of 1 weight % to 15 weight %, or 2 weight % to 10 weight % of the TPE. When the TPE contains a filler, it is preferred that the filler does not include a pigment.

The TPE may contain a polyolefin, e.g. polyethylene or polypropylene. For example, the TPE may contain polyethylene or polypropylene, or a combination or mixture of polyethylene and polypropylene, in the range of 5 weight % to 40 weight %, e. g in the range of 10 weight % to 30 weight %, or 15 weight % to 25 weight %.

In a specific embodiment, the TPE comprises an SBC, a polyolefin, and a process oil. For example, the SBC may be SEBS or SBS, and the polyolefin may be a polypropylene. The TPE may contain SBC in the range of 20 weight % to 70 weight %, e.g. 30 weight % to 60 weight %, polyolefin in the range of 1 weight % to 20 weight %, e.g. 5 weight % to 15 weight %, and oil in the range of 20 weight % to 60 weight %, e.g. 30 weight % to 40 weight %.

A TPE may also be defined by its compression set value, which corresponds to the deformation remaining after removal of a force that was applied to it (and is typically expressed in %). The compression set value is typically recorded over a specified period of time, e.g. in the range of 18 hours to 96 hours or 22 to 72 hours, and at a specified temperature, for example according to the ISO 815 standard. In the context of the present disclosure the compression set is generally recorded at an “ambient temperature”, e.g. in the range of 10 °C to 40 °C. However, the temperature range may also extend beyond ambient temperature, e.g. 23 °C to 100 °C. In general, the higher the temperature the shorter the time relevant for recording the compression set. The compression set should generally be as low as possible but for a stopper of the disclosure the compression set may be in the range of 15% to 45%, e.g. at ambient temperature. At higher temperatures, e.g. 100 °C, the compression set will typically be higher, e.g. up to 60%, e.g. up to 50%. It is, however, preferred that the compression set at ambient temperature is in the range of 10% to 45%. The compression set value is generally relevant for prefilled injectors where the stopper is inserted into the cylinder and therefore compressed when the prefilled injector is stored for extended periods of time. Correspondingly, the compression set value is also relevant for vials having a stopper made from a TPE.

Particularly relevant TPEs are provided by Alphagary (Melton Mowbray, Leicestershire, UK), e.g. TPEs referred to as the Evoprene, such as the G series or the R series. For example, the medical container may be a PFS, and the PFS may have a stopper, e.g. a piston, made from Evoprene G 970 or Evoprene R 9970. Otherwise, the medical container may be a vial, and the vial may have a stopper made from Evoprene G 968, G 967, G 962, G 958, or G 960 or Evoprene R 9068 or R 9067. Evoprene G 970 and Evoprene R 9970 are also particularly suited for single dose application vials.

The medical container may be a PFS. In particular, the medical container may be a PFS having a cylinder with a diameter equal to the transverse diameter of the inlet opening. Being a prefilled syringe, the medical container includes a liquid medicament, and the stopper has been exposed to a temperature below the T_{g} of the TPE before filling the medical container with the liquid medicament. Thus, for example, the medical container may be filled with a liquid medicament before inserting the stopper in the inlet opening and then cooling the PFS to a temperature below the T_{g} of the TPE. The present inventor has surprisingly found that when a syringe includes a stopper made from a TPE, the syringe can be cooled to a temperature below the T_{g} of the TPE and retain the container closure integrity (CCI) of the syringe during the cooling phase, e.g. the cooling from ambient temperature or a moderately lowered temperature, e.g. 5 °C or −18 °C, to the T_{g} of the TPE, and furthermore the temperature can be increased again from the T_{g} of the TPE to ambient temperature or another temperature at which the liquid medicament is to be injected into a patient, still without losing the CCI. At the T_{g}, a polymeric material is expected to become brittle, and combined with the shrinkage of the polymeric material caused by the cooling, a polymeric material is expected to compromise the CCI and create a risk of i.a. microbial ingression in a syringe with a stopper made from the polymeric material. However, for a PFS having a stopper made from TPE, this surprisingly does not occur, and the CCI is retained. Furthermore, the inventor has observed that even when the cooling is continued to lower temperatures, e.g. −80 °C, −100 °C or −196 °C, the CCI is still retained, and in an example, the stopper has been exposed to a temperature at or below −80 °C, −100 °C or −196 °C. The stopper may subsequently be heated from the T_{g} of the TPE to ambient temperature. Thereby, the invention provides a PFS that can be stored at cryogenic temperature before being adjusted to ambient temperature to allow the liquid medicament of the PFS to be injected into a patient. The effect is observed for PFSs having polymeric cylinders, e.g. a cylinder made from COC or COP, as well as glass cylinders.

By providing a medical container that can be stored at extreme freezing temperatures while retaining CCI, the present invention provides a medical container that is especially suited for storing a liquid medicament containing a sensitive drug, e.g. a drug based on nucleic acids, such as RNA, e.g. mRNA, and DNA, or amino acids, e.g. protein or peptide-based drugs.

The inventor has further observed that despite having been exposed to extreme freezing temperatures, e.g. T_{g} of the TPE, −80 °C, −100 °C or −196 °C, the PFS can be used without the need for an external lubricant, and moreover, there is also no need for the TPE to contain a slip agent. In particular, the inventor has surprisingly found that exposing the stopper to the temperature T_{g} of the TPE does not cause the stopper to become stuck, e.g. to form a stronger bond between the TPE of the stopper and the inner wall of the cylinder, so that the BLF of the PFS is generally unaffected by having been exposed to the extreme freezing temperatures. Thus, in an example, the medical container is a PFS, and the stopper does not contain an external lubricant, e.g. a silicone oil. In a further example, the medical container is a PFS, and the TPE of the stopper and/or the surface of the stopper, do not contain a slip agent, e.g. a salt of a divalent metal and stearate, e.g. magnesium stearate, calcium stearate or zinc stearate. In yet a further example, the medical container is a PFS, and the stopper does not contain an external lubricant, e.g. a silicone oil, and the TPE of the stopper does not contain a slip agent, e.g. a salt of a divalent metal and stearate, e.g. magnesium stearate, calcium stearate or zinc stearate. Certain materials commonly used for stoppers for syringes may cause what is known as a stick-in effect where the stopper after long term storage appears to stick to the wall of the cylinder thereby increasing the BLF. Thus, a stick-in effect may be expected for a PFS. The invention thus provides a PFS where no lubricant is present, which is especially suited for long term storage, since minimal to no stick-in effect occurs, long-term sealing is provided and negative effects on the pharmaceutical from a lubricant are avoided while still retaining a smooth end user experience.

In an example, the medical container is a vial. In another example, the medical container is a PFS, especially for parenteral administration of a liquid medicament. As a PFS, the medical container has a tubular outlet at the bottom end, and the PFS may be a fully integrated tool ready to use for injecting the liquid medicament into a patient, e.g. the medical container may also include a piston rod or the like and a hypodermic needle. However, the medical container may also be a cartridge or the like to be used with an appropriate tool for injecting the liquid medicament into a patient. In an example, the medical container is a PFS, and the bottom end has a tubular outlet. The tubular outlet may have any shape as appropriate for a syringe to inject a medical liquid contained in the cylinder of a medical container. Preferably, the tubular outlet extends from bottom end, in particular away from the inner space of the cylinder, along the longitudinal axis of the cylinder. The tubular outlet may comprise a fitting for attaching or mounting a hypodermic needle. For example, the tubular outlet may comprise an engagement device for engaging a complementary engagement device of a hypodermic needle, e.g. the engagement device and the complementary engagement device may comprise a male-female interaction, with the tubular outlet optionally comprising an external thread, e.g. a helical external thread, and the hypodermic needle optionally comprising a complementary internal thread, e.g. a helical internal thread. A hypodermic needle may be fitted to allow simple removal, and replacement, of the hypodermic needle, or the hypodermic needle may be mounted permanently on the injector. In particular, the hypodermic needle may be mounted on the injector so that its removal requires the destruction of the injector thereby preventing reuse, which in the context of the invention is considered “permanent”. In an example, the injector comprises a hypodermic needle attached, e.g. permanently attached, to the outlet of the cylinder.

In another example, the medical container is a PFS in the form of a cartridge having an outlet, typically located at the outlet end, and the outlet need only have a limited extension from the bottom end. The outlet of a cartridge is generally configured to provide fluid communication with a hypodermic needle of an injection device. The injection device to be used with the cartridge may also include a piston rod or similar configured to push the stopper from the inlet end of the cylinder to the bottom end. In another example, the medical container is a PFS in the form of a cartridge to be used in a needle free injector. A cartridge may also be referred to as a “carpule”.

When the medical container is a PFS, it may also comprise a needle cap for use as a piston rod. For example, the piston may be considered to have an actuating surface facing the inlet end of the cylinder and an outlet surface opposite the actuating surface thus facing the tubular outlet of the cylinder. In general, the distance from the inlet end of the cylinder to the tubular outlet of the cylinder minus the dimension of the piston parallel with the longitudinal axis of the cylinder defines an “operating length” of the cylinder. The needle cap may have a tubular section for housing the hypodermic needle the tubular section having a needle insertion end comprising an engagement device for engaging a complementary engagement device of the outlet or the hypodermic needle, and a needle protection end opposite the needle insertion end, which tubular section comprises a device for actuating the piston, with the length of the tubular section being equal to or larger than the operating length of the cylinder. The piston may be moved towards the tubular outlet using any means from the inlet end, for example the piston may be moved towards the tubular outlet using the needle cap also serving as a piston rod.

It is generally preferred that the stopper does not contain any external lubrication, e.g. a silicone lubricant. For example, the medical container may be a PFS that does not include lubricant, in particular a silicone lubricant. It is further preferred that the TPE of the stopper does not contain a slip agent. It is particularly preferred that the TPE of the stopper does not contain a slip agent, and the stopper does not include lubricant. The medical container may be a PFS that is considered to be free from a lubricant, in particular a silicone lubricant. Likewise, the medical container may also be a PFS that is considered to be lubricated only be the liquid medicament in the PFS. When the medical container is a non-lubricated PFS, it is preferred that the stopper has a Shore A hardness in the range of 50 to 80, e.g. 60 to 80, or 70 to 80. For example, the stopper, e.g. a stopper of a PFS of the present disclosure, may be made from Evoprene G970, Evoprene R9070 or from Evoprene R 9970 TPE (all three supplied by Alphagary).

The present medical container may be sterilised after filling with the liquid medicament, or the parts of the medical container may be sterilised prior to being filled with the liquid medicament. Sterilisation after packaging is typically referred to as “terminal sterilisation”, and in the present context, the term “gamma irradiation” is used to describe sterilisation using gamma irradiation at any stage, e.g. as a terminal sterilisation or sterilisation of the individual components of the medical components. However, sterilisation may be obtained using any appropriate procedure, such as using ethylene oxide (EtO), nitrogen dioxide (NO₂) or steam, e.g. in an autoclave, chlorine dioxide, hydrogen peroxide or liquid (such as glutaraldehyde, formaldehyde), other chemicals, or UV-ozone treatment. In general, sterilisation is performed in a manor where the substance of the medical container is not adversely affected, but the medical container is sterilised to attain a Sterility Assurance Level (SAL) of 10⁻⁶. For example, the parts of the medical container may be sterilised using nitrogen dioxide (NO₂), EO or steam prior to filling the medical container with a liquid medicament, or the medical container may be sterilised using nitrogen dioxide (NO₂), EO or steam after filling the medical container with a liquid medicament.

TPEs are generally suited for being sterilised using irradiation, such as gamma, electron beam (E-beam) as well as X-ray irradiation. Sterilisation using gamma, E-beam and X-ray irradiation is well-known to the skilled person. Sterilisation using irradiation, e.g. gamma irradiation, is generally referred to using the term “VDmax” followed by a number indicating the intended minimum dose. For example, the irradiation may be VDmax 25 or VDmax, where the doses are 25 kGy to 45 kGy, and 50 kGy to 90 kGy, respectively. In an example of the present disclosure, the stopper has been sterilised using irradiation, e.g. gamma irradiation, at a dose in the range of 25 kGy to 45 kGy, e.g. 25 kGy to 35 kGy or 29 kGy to 33 kGy, e.g. the stopper has been irradiated under VDmax 25. In another example. the stopper has been irradiated under VDmax 50, i.e. at a dose in the range of 50 kGy to 90 kGy. Regardless what time of irradiation is employed, the irradiation is generally classified with the irradiation dose. The stopper may be gamma irradiated after filling the medical container, e.g. a vial or a PFS, with the liquid medicament, i.e. the medical container may be terminally sterilised using gamma irradiation. However, gamma irradiation of a vial filled with a drug may be damaging to the drug, in particular a drug based on nucleic acids, such as RNA, e.g. mRNA, or DNA, or amino acids, e.g. protein or peptide-based drugs, and correspondingly, small molecule drugs may also be damaged by gamma irradiation. It is thus preferred not to subject the medical container to terminal sterilisation by gamma irradiation. In another example, the stopper is gamma irradiated before filling the medical container with the liquid medicament. In a further example, the stopper is gamma irradiated before filling the medical container with the liquid medicament, and the medical container is not exposed to terminal sterilisation, in particular, the medical container is not exposed to terminal sterilisation by gamma irradiation. The present inventor has now surprisingly found that if the stopper is subjected to gamma irradiation above 45 kGy, in particular above 50 kGy or even higher, before the stopper is inserted into the cylinder, the irradiation creates a risk of leak in a medical container with the irradiated stopper. Thereby, the irradiated TPE stopper may not comply with the CCI requirements. The present inventor believes that the cause of this loss of CCI by the gamma irradiation is cross-linking of the molecules of the TPE. In general, it is considered that gamma radiation may cross-link molecules of a polymer, and when the material is brought in contact with another material prior to irradiation, the molecules of the polymer may also be cross-linked with molecules of material that is in contact with the polymer. This effect is useful when a medical vial having a TPE stopper is terminally sterilised using gamma irradiation, as it ensures that the terminally sterilised vial complies with the CCI requirements, and in this case the terminal sterilisation may employ gamma irradiation up to the level acceptable for the relevant polymer or TPE. Thus, by sterilising the TPE stopper with gamma irradiation at a dose in the range of 25 kGy to 45 kGy, prior to inserting the gamma irradiated TPE stopper in a medical container, the present invention provides a gamma sterilised TPE stopper providing a long term sealing effect so that a medical container with the gamma sterilised TPE stopper complies with CCI requirements, in particular for storage of a liquid medicament for more than a month.

The present inventor has further surprisingly observed that appropriate sterilisation of the stopper may also be achieved at a lower dose of irradiation. Thus, in an example of the present disclosure, the stopper has been sterilised using irradiation, e.g. gamma irradiation, at a dose in the range of 10 kGy to 25 kGy. Correspondingly, the stopper may have been irradiation at a dose of irradiation in the range of 10 kGy to 45 kGy.

Once the medical container is provided in a sterilised form, the medical container may be packaged in a secondary packaging. The secondary packaging encloses the medical container in a further packaging, such as plastic wrapping, foil wrapping, paper wrapping or other suitable wrapping, e.g. a blister pack, and the secondary packaging may contain multiple units of the medical container. The medical container before packaging in the secondary container is commonly referred to as a “primary packaging”, and in the present context, the sterilised medical container may be referred to as the “primary medical container”. A sterilised, e.g. a primary, medical container is traditionally removed from aseptic conditions before packaging in a secondary packaging, and thereby there is a risk that the surface of the primary packaging is not sterile, even though the contents of the primary medical container are sterile. In an example, the primary medical container is packaged in a secondary packaging, and the secondary packaging is then sterilised. In particular, the secondary packaging may be sterilised to sterilise the outer surface of the primary medical container in the secondary packaging. Sterilisation of the secondary packaging may be performed prior to or after cooling the stopper to a temperature below the T_{g} of the TPE. Any sterilising method may be employed to sterilise the secondary packaging. However, the sterilising method is preferably selected to minimise the risk of damaging the drug in the primary medical containers contained in the secondary packaging. For example, the secondary packaging may be irradiated, e.g. using gamma rays or an E beam at a dose in the range of 0.1 kGy to 10 kGy, e.g. 1 kGy to 5 kGy. However, the secondary packaging may alternatively be irradiated at a dose in the range of 0.1 kGy to 45 kGy, e.g. 25 kGy to 45 kGy. TPE materials, in particular styrene-based TPEs, e.g. Evoprenes such as R9970 and R9070, and the G series, e.g. G970, are resistant to irradiation and therefore, by using irradiation for sterilisation in this dosage range for a secondary packaging with a medical container of the present disclosure provides a sterilised medical container that can be used in an aseptic setting, e,g, an operating room in a hospital, without concern the surface of the primary medical is contaminated.

Thus, despite the cross-linking caused by the gamma irradiation, the TPE retains its elastic properties, and thereby the gamma irradiated TPE can be used to ensure CCI for the medical container, and the effect obtained by sterilising the stopper using gamma irradiation at a dose in the range of 25 kGy to 45 kGy is relevant both when the stopper is a stopper for a vial and when the stopper is a piston for a syringe. Moreover, the stopper may be exposed to a temperature below the T_{g} of the TPE, and also gamma irradiated with a gamma irradiation at a dose in the range of 25 kGy to 45 kGy without compromising the CCI. In an example, the medical container is a vial, and the stopper has been sterilised using gamma irradiation at a dose in the range of 25 kGy to 45 kGy. In another example, the medical container is a PFS, and the stopper has been sterilised using gamma irradiation at a dose in the range of 25 kGy to 45 kGy.

Exemplary stoppers for a PFS of the present disclosure are described in WO 2019/185101, EP 3003440, and WO 2017/157396, which are incorporated by reference herein in their entireties.

In an example, the stopper includes a cavity extending from a stopper cavity opening to a stopper cavity base to define a total stopper cavity length. The stopper cavity opening may be located in the actuating surface of the stopper, and the cavity may extend into the stopper from the actuating surface. Alternatively, the cavity may extend into the stopper from the inner surface. The stopper with a cavity extending into the stopper from the actuating surface is generally referred to as a “cavity stopper” in the present context. For example, the cavity may be located in the stopper body, which has a deformable sealing element surrounding the stopper body. The cavity stopper is relevant for a vial and also for a PFS.

In general, the cavity stopper is inserted in the inlet opening with the cavity opening facing the ambient exterior of the medical container and the stopper cavity base facing the liquid medicament. The cavity stopper may have one deformable sealing element, or the cavity stopper may have two or more deformable sealing elements. When the cavity stopper has two or more deformable sealing elements, each of the deformable sealing elements may be identical, e.g. with respect to its outer diameter, or the deformable sealing elements may be different. In general, the deformable sealing element(s) is located on the cavity stopper between the actuating surface and the cavity base.

In an example, the medical container is a vial. In general, when the medical container is a vial, the vial includes a cylinder with an inner space and the cylinder may have a cross-sectional shape and a cross-sectional dimension that are different from at least one of the cross-sectional shape and the cross-sectional dimension of the inlet opening and the inlet section. The vial may have any volume commonly observed for vials used for storing liquid medicaments, e.g. the volume of the vial may be in the range of 1 ml to 50 ml.

The vial has an inlet opening for receiving the stopper, and along the perimeter of the inlet opening, the vial will therefore also have a perimeter surface, the area of which in the simplest form corresponds to the thickness of the material of the vial and the cross-sectional size and shape of the inlet opening. In an example, the medical container is a vial, and the stopper has a circumferential ridge surrounding the stopper body. When present, the circumferential ridge is located between the actuating surface of the stopper and the deformable sealing element. The circumferential ridge is sized so that the stopper cannot be inserted into the inlet opening beyond the circumferential ridge. For example, the inlet opening is circular, and the circumferential ridge is also circular and has a diameter larger than the transverse diameter. The diameter of the circumferential ridge is also larger than the diameter of the deformable sealing element. The circumferential ridge has a contact surface facing the inner surface of the stopper. After insertion of the stopper into the inlet opening, the contact surface abuts the perimeter surface. When the contact surface abuts the perimeter surface a sealing effect is obtained.

In a specific example, the medical container is a vial, and the vial further comprises a flange surrounding the inlet opening, and this flange thereby increases the area of the perimeter surface. For example, the inlet opening may be circular, and the flange may also be circular and have a diameter in the range of 105% to 150%, e.g. 110% to 125% of the transverse diameter. The diameter of the flange may also be referred to as the flange diameter. However, the flange need not have the same cross-sectional shape as the inlet opening. Vials for medical containers are traditionally closed with a stopper made from an elastomer and sealed using a crimp cap, e.g. a crimp cap made from aluminium. By being larger than the inlet opening, the flange provides the vial with a capping surface opposite the perimeter surface. A crimp cap can be folded around the flange so that the crimp cap engages the capping surface. The crimp cap thereby ensures CCI for the vial.

It is preferred that the stopper is inserted into the vial after filling the medical container with the liquid medicament. Once the vial has been closed by insertion of the stopper, the liquid medicament can be extracted by piercing the stopper with a hypodermic needle mounted on appropriate syringe and extracting the liquid medicament via the hypodermic needle. The stopper may have a piercing area, and the piercing area may be marked on the stopper. The thickness of the stopper at the piercing area is appropriate for being, e.g. the piercing area is configured to be, pierced with a hypodermic needle, in particular the thickness is sufficiently low to avoid that the hypodermic needle loses its sharpness and can be used to administer the liquid drug to a patient without causing excessive pain upon piercing the skin of the patient with the hypodermic needle. For example, the thickness of the stopper at the piercing area may be in the range of 0.3 mm to 3 mm. The present inventor has surprisingly found that by using a TPE having a high Shore A hardness, the thickness of the TPE of the stopper at the piercing area can be reduced compared to a stopper prepared from a softer TPE. In an example, the TPE of the stopper has a Shore A hardness in the range of 50 to 65, e.g. 50 to 60, or 50 to 55, and the thickness of the stopper at the piercing area is in the range of 0.3 mm to 2 mm, e.g. 0.4 mm to 1.9 mm, or 0.5 mm to 1.8 mm. The higher hardness of the TPE further provides that the seal between the deformable sealing element and the inner wall of the cylinder in the inlet section or at the inlet opening is improved, and the sealing effect may be improved to an extent where CCI is ensured by the deformable sealing element. A TPE stopper with a Shore A hardness in the range of 50 to 60, and a thickness at the piercing area in the range of 0.3 mm to 2 mm, e.g. 0.4 mm to 1.9 mm, or 0.5 mm to 1.8 mm, is particularly useful for a vial intended for storing a liquid medicament at temperatures below the T_{g} of the TPE. Thus, in an example, the TPE of the stopper has a Shore A hardness in the range of 50 to 60, and the deformable sealing element has an outer diameter that is 2% to 10%, e.g. 3% to 5%, larger than the transverse diameter, when the deformable sealing element is in a relaxed state. The sealing effect is further improved by having two or more deformable sealing elements on the stopper. It is further preferred that the thickness of the stopper at the piercing area is in the range of 0.3 mm to 2 mm, e.g. 0.4 mm to 1.9 mm, or 0.5 mm to 1.8 mm. In a further example, the stopper does not have a circumferential ridge, and the TPE of the stopper has a Shore A hardness in the range of 50 to 60, and the stopper has one, two or three deformable sealing elements with an outer diameter that is 2% to 10%, e.g. 3% to 5%, larger than the transverse diameter, when the deformable sealing element is in a relaxed state, and the stopper has a piercing area with a thickness of the stopper material at the piercing area being in the range of 0.3 mm to 2 mm, e.g. 0.4 mm to 1.9 mm, or 0.5 mm to 1.8 mm. It is further preferred that the vial does not have a flange surrounding the inlet opening. In this example, the CCI is ensured by the interaction of the deformable sealing element(s) with the inner wall of the cylinder at the inlet section or inlet opening so that there is no need for a crimp cap. Thereby, the invention provides a vial for storing a liquid medicament, in particular at a at temperature below the T_{g} of the TPE, which does not require a crimp cap. In a specific example, the vial does not include a crimp cap.

In an example, the medical container is a vial, and the stopper is a cavity stopper. For example, the stopper may have a cavity extending from the actuating surface into the stopper to the cavity base with the stopper further having at least one deformable sealing element between the actuating surface and the cavity base, e.g. along the length of the stopper. In another example, the deformable sealing element is located at the position of the cavity base, e.g. as seen from the actuating surface. When the vial has a cavity stopper, the piercing area is preferably located at the cavity base. A cavity stopper can advantageously be inserted into the vial using the method disclosed in PCT/DK 2022/050297 (published as WO 2023/232208) and thereby minimise the amount of air in the vial after the vial with the stopper. In a further example, medical container is a vial and the stopper is a cavity stopper, and the stopper does not include a circumferential ridge. In particular, the cavity stopper may have two or more deformable sealing elements.

In an example, the stopper has a hollow section extending from the inner surface of the stopper, and the stopper does not comprise a deformable sealing element, so that at least a section of the stopper body, i.e. a section along the length of the stopper, is the sealing surface. The stopper may further comprise a circumferential ridge, e.g. a circumferential ridge extending from the actuating surface of the stopper, and the hollow section may extend from inner surface to a base of the hollow section. The hollow section base may correspond to the location of the circumferential ridge. The stopper has a piercing area located in the actuating surface of the stopper, and the thickness of the material stopper at the piercing area corresponds to the distance from the actuating surface to the hollow section base. It is especially preferred that the TPE of the stopper in this example has a Shore A hardness in the range of 50 to 65, e.g. 50 to 60 or 50 to 55. It is further preferred that the thickness of the TPE at the piercing area is in the range of 0.3 mm to 2 mm, e.g. 0.4 mm to 1.9 mm, or 0.5 mm to 1.8 mm. A vial with this stopper may comprise a crimp cap, e.g. a crimp cap made from aluminium.

Certain vials of the prior art, e.g. a stopper with a hollow section as described above, are filled by piercing the closure with a hypodermic needle and injecting a drug into the vial and then resealing the closure using laser welding. The need to pierce a closure of a vial creates an unnecessary risk of polluting or contaminating the inside of the vial, and furthermore, the laser welding heats the TPE to melt it and the thereby laser welding exposes the content of the vial to heat that can damage sensitive drugs, especially mRNA based drugs, but also drugs based on DNA or protein. Using laser welding is therefore undesirable. Furthermore, using the laser welding requires a TPE that can absorb the laser light, typically infrared laser light, e.g. at a wavelength above 800 nm. Laser absorption is commonly obtained by including dyes or pigments in the TPE. For the vial of the present disclosure, it is preferred that the TPE does not contain pigments or dyes.

The cavity stopper may be used with the PFS of the present disclosure. When the medical container is a PFS and the stopper is a cavity stopper, the cavity stopper may comply with any stopper disclosed in WO 2019/185101. For example, the cavity stopper may have an actuating surface opposite an inner surface and an axial length between the actuating surface and the inner surface, with the deformable sealing element being located at an axial location from the actuating surface, at which axial location a widened cavity having an axial extension in the range of 5% and 50% of the axial length of the stopper body and a lateral extension that is at least 50% of the outer diameter of the deformable sealing element is also located. In general, the section of the cavity from the actuating surface to the widened cavity has a diameter below the diameter of the widened cavity.

In another aspect, the invention relates to a method of manufacturing a medical container of the present disclosure. The method comprises the steps of:
providing a cylinder extending along a longitudinal axis, the cylinder having an inner wall, an inlet opening at an inlet end and a bottom end opposite the inlet end, which inlet opening defines a transverse diameter, which cylinder is made from glass or a polymeric material, which medical container is made from glass or a polymeric material;
applying a liquid medicament in the medical container;
inserting the stopper in the inlet to provide a filled medical container; and
lowering the temperature of the filled medical container to a temperature below the T_{g} of the thermoplastic elastomer of the stopper.

The method may further comprise the step of increasing the temperature of the filled medical container from the T_{g} of the thermoplastic elastomer of the stopper to ambient temperature. The cylinder for use in the method of the disclosure may be any example of the cylinder disclosed for the aspect relating to the medical container of the disclosure. In general, any variation or feature described for the medical container of the disclosure is equally relevant for the method of the disclosure.

In an example, the method further comprises the step of sterilising at least one of, e.g. both of, the cylinder and the stopper with nitrogen dioxide (NO₂). The cylinder and/or the stopper may be sterilised using nitrogen dioxide (NO₂) prior to or after the step of applying a liquid medicament in the cylinder, e.g. the cylinder and/or the stopper may be sterilised using nitrogen dioxide (NO₂) after inserting the stopper in the inlet opening. The cylinder and/or the stopper are generally sterilised using nitrogen dioxide (NO₂) prior to the step of lowering the temperature of the filled medical container to a temperature below the T_{g} of the thermoplastic elastomer of the stopper. Sterilisation using nitrogen dioxide (NO₂) is known to the skilled person, and any conventional procedure may be used for the sterilisation.

In an example, the stopper is a cavity stopper, and the stopper is inserted into the medical container, e.g. a PFS or a vial, as disclosed in WO 2023/232208, which is hereby incorporated by reference herein in its entirety. Thus, the stopper may have an actuating surface facing an ambient exterior of the medical container, which stopper includes a cavity extending from a stopper cavity opening in the actuating surface to a stopper cavity base, and the method may further comprises the steps of:
providing a stopper extension rod having a total length of at least 5% more than the total cavity length, and an impact surface,
inserting the stopper extension rod in the cavity of the stopper and impacting the cavity base with the impact surface at a velocity of at least 25 mm/min to extend the stopper along a cylinder longitudinal axis and cause a contraction of the deformable sealing element to create a bypass of air in the space between the stopper and a drug upper surface; and
maintaining the velocity of the stopper extension rod to move the piston to a final piston position.

In a specific example, the method may comprise the steps of:
providing a medical container comprising a cylinder with an inlet opening and having a longitudinal axis and an inner wall, and a liquid medicament defining a drug upper surface,
providing a cavity stopper,
inserting the cavity stopper in the inlet opening so that the deformable sealing element abuts the inner wall of the inlet opening and seals an annular gap between the piston and the inner wall of the inlet opening,
providing a stopper extension rod having a total length of at least 5% more than the total cavity length, and an impact surface,
inserting the stopper extension rod in the cavity of the cavity stopper and impacting the cavity base with the impact surface at a velocity of at least 25 mm/min to extend the cavity stopper along the cylinder longitudinal axis and cause a contraction of the deformable sealing element to create a bypass of air in the space between the cavity stopper and the drug upper surface, and
maintaining the velocity of the stopper extension rod to move the piston to a final piston position. The velocity may for example be in the range of 50 mm/min to 120,000 mm/min, such as in the range of 1,000 mm/min to 50,000 mm/min, e.g. 2,000 mm/min to 40,000 mm/min, 3,000 mm/min to 30,000 mm/min, 4,000 mm/min to 20,000 mm/min or 5,000 mm/min to 10,000 mm/min.

The cavity stopper is advantageous for a vial, and especially when the cavity stopper is inserted into the inlet opening using the stopper extension rod as outlined above. The cavity stopper can be inserted into the vial, i.e. the inlet opening of the medical container, so that there is a minimal distance, e.g. no distance, between the inner surface of the cavity stopper and the drug upper surface. Thereby, the invention provides a vial with a minimum amount of air or gas in the vial after closing the vial with the stopper.

Any embodiment of the invention may be used in any aspect of the invention, and any advantage for a specific embodiment applies equally when an embodiment is used in a specific aspect.

### BRIEF DESCRIPTION OF THE DRAWINGS

In the following the invention will be explained in greater detail with the aid of an example and with reference to the schematic drawings, in which

FIG. 1 shows an embodiment of a vial of the invention;

FIG. 2 shows an embodiment of a vial of the invention;

FIG. 3 shows an embodiment of a vial of the invention;

FIG. 4 shows an embodiment of a vial of the invention;

FIG. 5 shows an embodiment of a stopper for a vial of the invention;

FIG. 6 shows an embodiment of a stopper for a vial of the invention;

FIG. 7 shows an embodiment of a stopper for a vial of the invention;

FIG. 8 shows an embodiment of a stopper for a PFS of the invention;

FIG. 9 shows details of an embodiment of a PFS of the invention;

FIG. 10 shows an embodiment of a PFS of the invention;

FIG. 11 shows the filling of a medical container in a method of the invention;

FIG. 12 shows measurements of break loose and slide forces for a PFS of the invention.

The invention is not limited to the embodiment/s illustrated in the drawings. Accordingly, it should be understood that where features mentioned in the appended claims are followed by reference signs, such signs are included solely for the purpose of enhancing the intelligibility of the claims and are in no way limiting on the scope of the claims.

The term “comprising” as used in this specification and claims means “consisting at least in part of”. When interpreting statements in this specification and claims which include the term “comprising”, other features besides the features prefaced by this term in each statement can also be present. Related terms such as “comprise” and “comprised” are to be interpreted in a similar manner.

### DETAILED DESCRIPTION

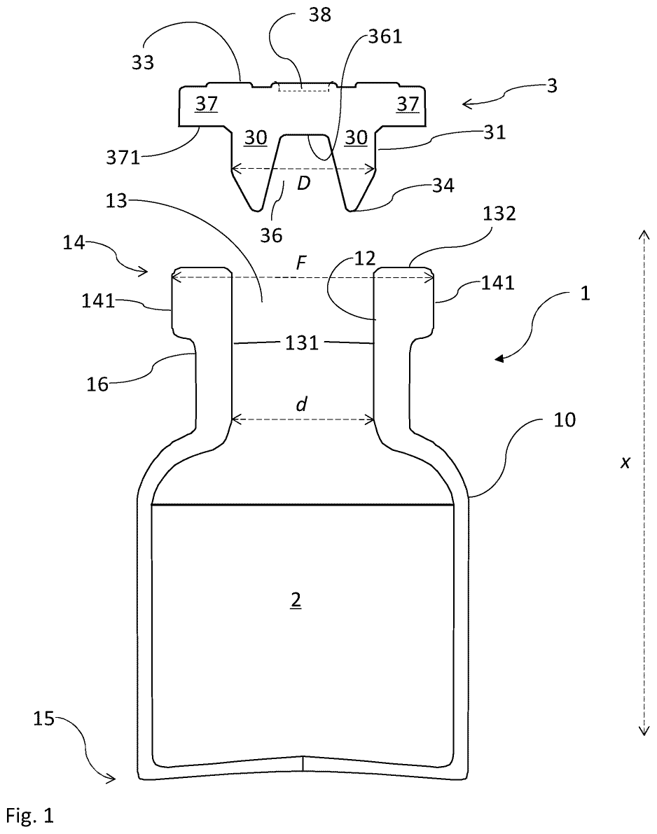

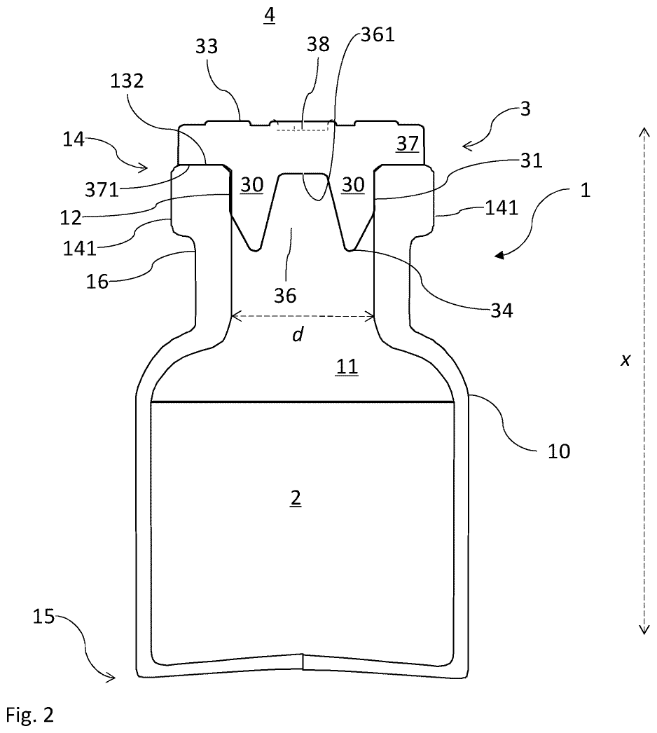

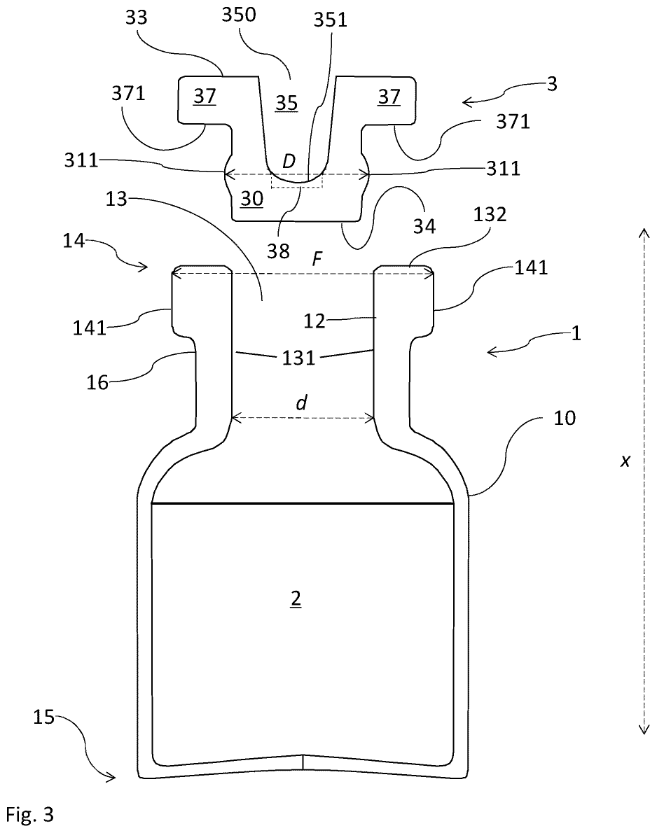

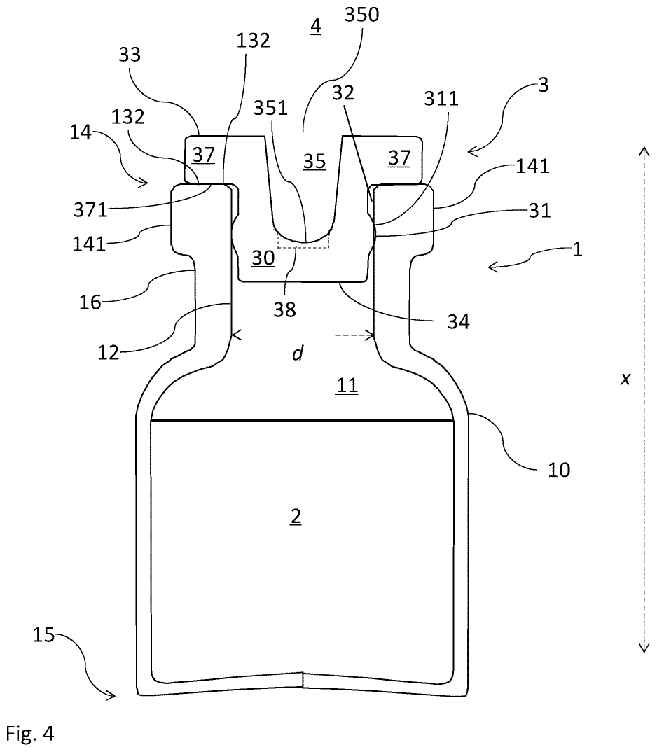

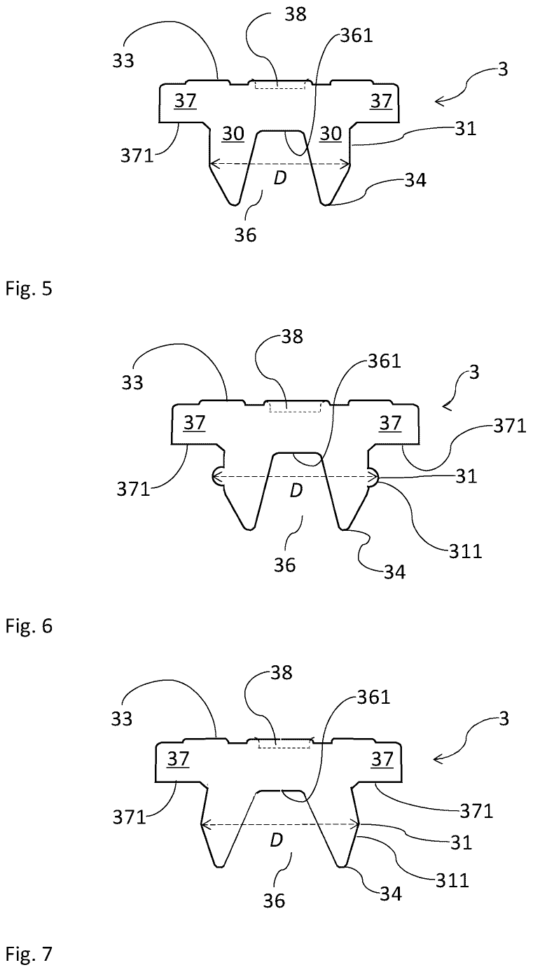

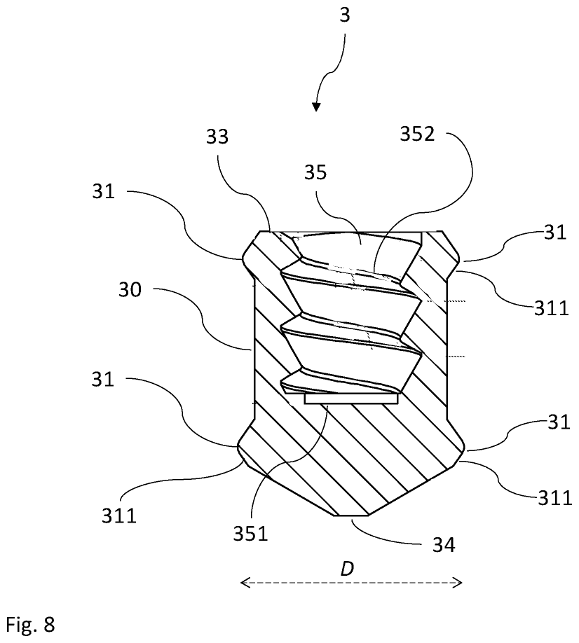

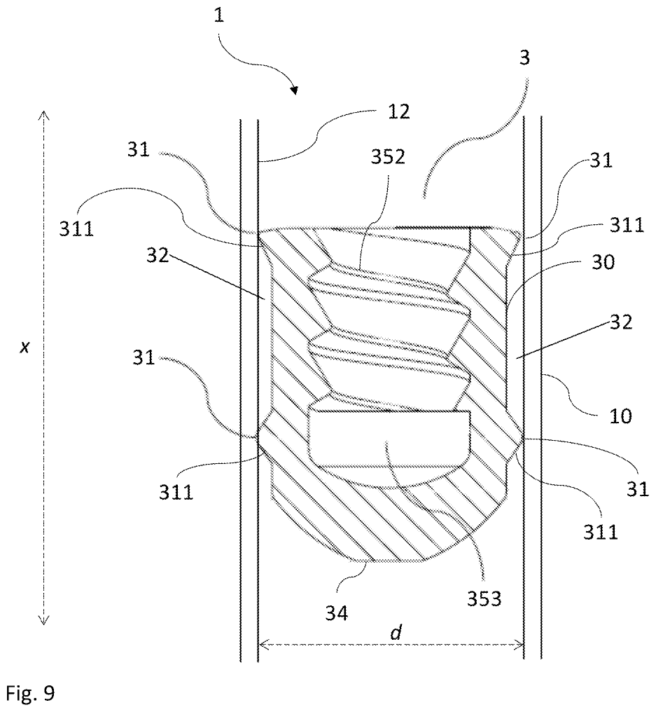

The present invention relates to a medical container 1 for storing a liquid medicament 2. The medical container 1 may in particular be a vial 1 or a prefilled syringe (PFS) 1. A vial 1 of the invention is shown FIG. 1 and FIG. 2, where FIG. 1 shows the stopper 3 before insertion into the vial 1 and FIG. 2 shows the stopper 3 inserted into the vial 1. Corresponding illustrations are shown in FIG. 3 and FIG. 4 with another embodiment of the stopper 3. Variations of the stopper 3 for a vial 1 are shown in FIG. 5, FIG. 6 and FIG. 7. FIG. 8 shows a stopper 3 for use with a PFS 1 of the invention, and FIG. 9 shows the cylinder 10 of a PFS 1 of the invention with the stopper 3 inserted into the cylinder 10.

Thus, FIG. 1, FIG. 2, FIG. 3 and FIG. 4 show a vial 1 made from borosilicate glass with a stopper 3 injection moulded from an Evoprene TPE, relevant examples are R 9068 or R 9067. The same vial 1 is shown in FIG. 1 and FIG. 2, and in FIG. 3 and FIG. 4, respectively. The vial 1 includes a cylinder 10 with an inlet opening 13 at the inlet end 14, which inlet end 14 is opposite the bottom end 15. The length of the cylinder 10 along the longitudinal axis x of the cylinder 10 is 35 mm. The cylinder 10 has an outer wall 16. The inlet opening 13 has a transverse diameter d and defines an inlet section 131. The length of the inlet section 131 along the longitudinal axis x of the cylinder 10 is 8 mm. The transverse diameter d is 7 mm. A flange 141 surrounds the inlet opening 13, and this flange 14 defines an area of the perimeter surface 132. The flange 14 has a flange diameter F. Before insertion of the stopper 3, the cylinder 10 is filled with a liquid medicament 12.

In FIG. 1 and FIG. 2, the stopper 3 is of a conventional design and thus has a stopper body 30 defining a sealing surface 31 having an outer diameter D. The outer diameter D in FIG. 1 and FIG. 2 corresponds to the outer diameter of the stopper body 30. The transverse diameter d is 7 mm, and the outer diameter D is 7.2 mm. The stopper 3 has an actuating surface 33 opposite an inner surface 34. Once the stopper 3 is inserted into the inlet opening 13 in the inlet section 131, the inner surface 34 faces the liquid medicament 2, and the actuating surface 33 faces the ambient exterior 4 of the medical container 1 after insertion into the inlet opening 13. The stopper 3 has a circumferential ridge 37, which has a contact surface 371. When the stopper 3 is inserted into the inlet opening 13, the contact surface 371 abuts the perimeter surface 132. After insertion of the stopper 3 into the inlet opening 13, the medical container may be provided with an aluminium crimp cap (not shown) to further ensure container closure integrity (CCI). The stopper 3 includes a hollow section 36 with a base 361 of the hollow section 36. When the stopper 3 is inserted into the inlet opening 13, the base 361 faces the liquid medicament 2. The stopper 3 has a piercing area 38 at the actuating surface 33. Piercing of the stopper 3 at the piercing area 38 with a hypodermic needle (not shown) or the like will penetrate the material of the stopper 3 and provide access to the liquid medicament 2. The thickness of the material of the stopper 3 between the piercing area 38 and the hollow section base 361 is 2 mm.

In FIG. 3 and FIG. 4, the cylinder 10 is as described for FIG. 1 and FIG. 2 and the stopper 3 has a convex deformable sealing element 311. The convex deformable sealing element 311 defines the outer diameter D and provides the sealing surface 31. The transverse diameter d is 7 mm, and the outer diameter D is 7.3 mm. The stopper body 30 has a diameter of 6.5 mm so that there is an annular gap 32 between the inner wall 12 and the stopper body 30 when the stopper 3 is inserted into the cylinder 10. The stopper 3 includes a cavity 35 extending from a stopper cavity opening 350 in the actuating surface 33 to a base 351 of the cavity 35. When the stopper 3 is inserted into the inlet opening 13, the base 361 faces the ambient exterior 4. The stopper 3 has a piercing area 38 at the base 351. Piercing of the stopper 3 at the piercing area 38 with a hypodermic needle (not shown) or the like will penetrate the material of the stopper 3 and provide access to the liquid medicament 2. The thickness of the material of the stopper 3 at the piercing area 38 is 2 mm.

A stopper 3 corresponding to the stopper 3 of FIG. 1 is shown in FIG. 5, and variations of the stopper 3 are shown in FIG. 6 and FIG. 7. The stoppers 3 of FIG. 6 and FIG. 7 have different designs of the deformable sealing element 311, although in both cases, the deformable sealing elements 311 are convex deformable sealing elements 311.

A stopper 3 for a PFS 1 of the invention is shown in FIG. 8 and FIG. 9 shows a cylinder 10 of a PFS 1 with a stopper 3 inserted into the cylinder 10. The cylinder 10 of the PFS 1 has an inner wall 12 and defines a transverse diameter d. In both FIG. 8 and FIG. 9, the stopper 3 has two convex deformable sealing elements 311, which provide the sealing surface 31. When the stopper 3 is inserted into the cylinder 10, an annular gap 32 is formed between the inner wall 12 and the stopper body 30. As shown in FIG. 8 and FIG. 9, the stopper has a cavity 35 for receiving a piston rod (not shown). The cavity 35 includes a helical thread 352 complementary to a helical thread of the piston rod (not shown). The cavity 35 has a cavity base 351, and in FIG. 9, the stopper 3 further comprises a broad cavity 353 as defined in WO 2019/185101.

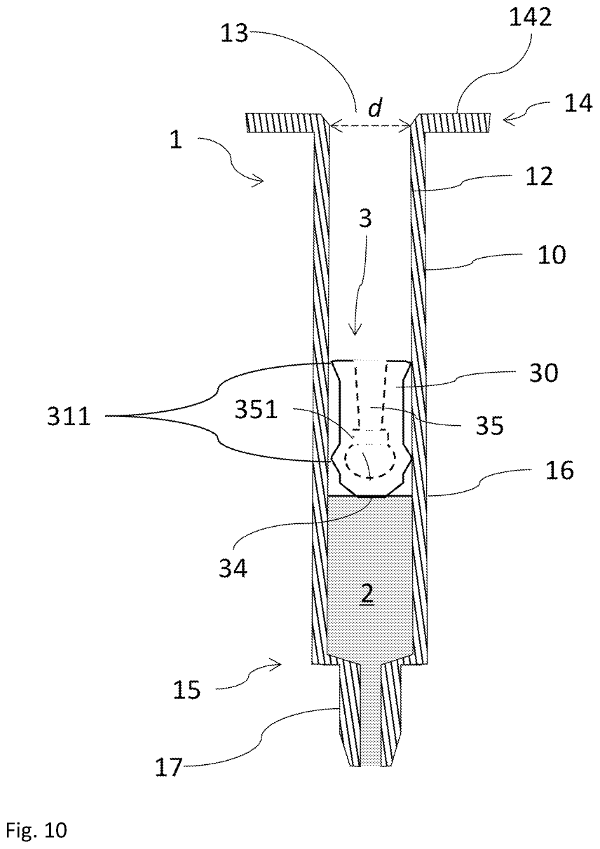

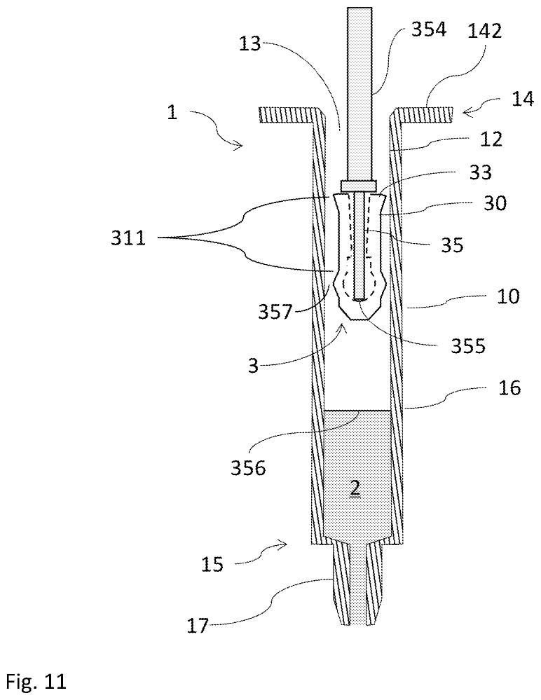

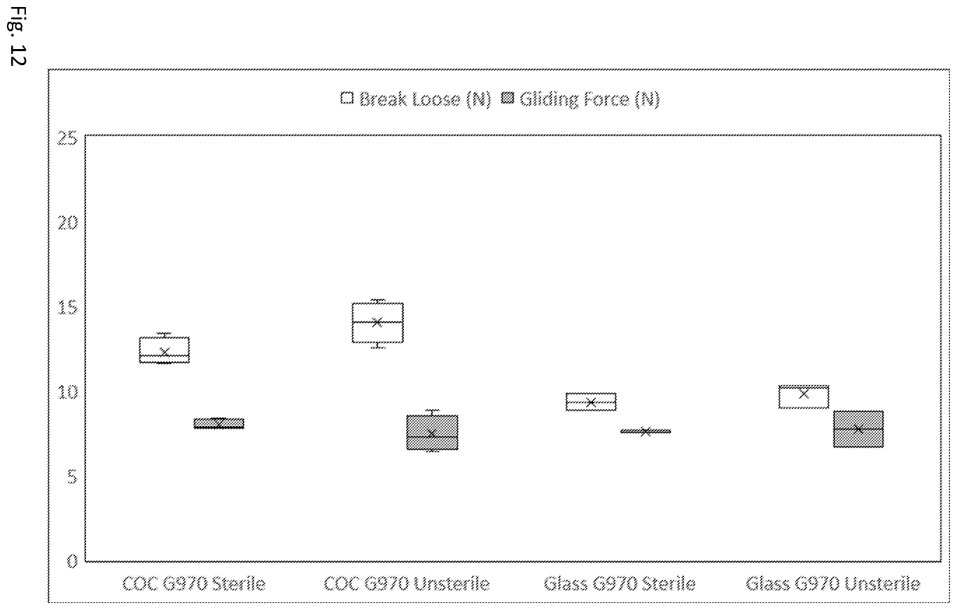

A PFS 1 of the invention is illustrated in FIG. 10. FIG. 10 shows the cylinder 10 made from COP. Specifically, the cylinder 10 is for a 0.5 ml PFS and has an inner diameter, i.e. the transverse diameter d of 4.65 mm. The cylinder has a finger grip 142 at the inlet end 14 and a tubular outlet 17 at the bottom end 15. A hypodermic needle (not shown) can be mounted at the tubular outlet 17. The cylinder 10 has an inner wall 12 and an outer wall 16.

A stopper 3 has been injection moulded from Evoprene R9070 to have two convex deformable sealing elements 311 and a cavity 35. The cavity 35 is a widened cavity 35 located at the axial location from the actuating surface 33 of the convex deformable sealing element 311 closer to the inner surface 34 of the stopper 3. The widened cavity 35 allows the stopper 3 to be inserted into the PFS using the method disclosed in PCT/DK2022/050297. The widened cavity 35 further provides a reduced BLF as disclosed in WO 2019/185101.

For the PFS shown in FIG. 10, the stopper 3 was inserted into the PFS at a velocity of 20,000 mm/min, but otherwise a velocity in the range of 500 mm/min to 120,000 mm/min is also useful.

FIG. 1 illustrates the filling of a medical container 1 in a method of the invention that uses a stopper extension rod 354. Specifically, the stopper 3 has an actuating surface 33 facing an ambient exterior 4 of the medical container 1, and the stopper 3 includes a cavity 35 extending from a stopper cavity opening 350 in the actuating surface 33 to a stopper cavity base 351, and a convex deformable sealing element 311 having a diameter larger than the transverse diameter d. The cylinder 10 is filled with a liquid medicament 2 to provide a drug upper surface 356, and the stopper 3 is inserted into the cylinder 10 prior to inserting the stopper extension rod 354 at a velocity to deform the stopper 3 upon impact of the impact surface 355 with the cavity base 351 and cause a contraction of the deformable sealing element 311 to create a bypass of air 357 in the space between the stopper 3 and the drug upper surface 356. Thereby, by maintaining the velocity of the stopper extension rod 354 the stopper 3 can be moved to a final stopper position and avoid air between the stopper 3 and the drug upper surface 356.

### Example 1

Two groups of 0.5 ml PFSs of the invention were produced, with one group having a cylinder made from borosilicate glass and the other group a cylinder made from cyclic olefin copolymer (COC). Stoppers were injection moulded from Evoprene G970 (provided from Alphagary) to have two convex deformable sealing elements. Specifically, the stoppers were as disclosed and illustrated in FIG. 1 of EP 3003440 B1. The cylinders were non-lubricated and had inner diameters, i.e. the transverse diameter d, of 4.65 mm, and the stoppers were unsiliconised or without any other lubricant or coating.

A subset of the stoppers was exposed to 30 kGy gamma irradiation and another subset of the stoppers was not exposed to gamma irradiation. The irradiated stoppers and the non-irradiated stoppers were inserted into the cylinders filled with Water for Injection (WFI) to provide the PFSs before freezing the PFSs at −80 °C, i.e. below the glass transition temperature (T_{g}) of the G970 TPE.

The PFSs were stored at −80 °C for six days before readjusting the temperature to ambient temperature and storing the PFSs in a climate chamber at 40 °C/75% relative humidity (RH) for four days in a test for CCI before measuring the break loose force (BLF) and glide force. Testing was based on ISO 7886-3: 2005 Annex B Sterile hypodermic syringes for single use—Part 3: Auto-disable syringes for fixed-dose immunisation, Test method for forces required to operate plunger. An Instron mechanical testing machine equipped with 100 N load cell was employed at 100 mm/min.

The tests for CCI were based on Pharmaceutical Package Integrity, Parenteral Drug Association's Technical Report No. 27, 1998. The PFSs were laid on absorbent paper in a desiccator with the vacuum after readjustment to ambient temperature. No leakage was observed for any specimen and it was concluded that the PFSs comply with CCI requirements. Thus, PFSs having a stopper injection moulded from a TPE were not affected by being frozen to below the T_{g} of TPE, i.e. Evoprene G970, and the PFSs complied with the requirements for CCI. Correspondingly, the gamma irradiation did not affect the sealing capabilities, and gamma irradiation, i.e. at a dose in the range of 25 kGy to 45 kGy, did not jeopardise the CCI.

The results of the BLF and glide force tests are shown in FIG. 12. In FIG. 12, “Sterile” indicates samples having been exposed to gamma irradiation, and “Unsterile” indicates samples not having been exposed to gamma irradiation, the Y axis shows the force in Newton (N) where the white markers illustrate the BLF and the grey markers illustrate the glide force. For the PFSs having a glass cylinder, the gamma irradiation did not change the BLF and the glide forces, whereas for the COC cylinders, the gamma irradiation surprisingly lowered the BLF, but still without jeopardising the CCI of the corresponding PFSs.

The test results observed for the PFSs of the invention apply equally to vials having an injection moulded TPE stopper. In particular, the Evoprene G970 has a Shore A hardness of 70 to 72, and with this Shore A hardness, the convex deformable sealing elements thus provide a stopper for a vial where CCI is ensured by the convex deformable sealing elements so that the vial does not require a crimp cap to seal the vial, e.g. via a circumferential ridge of the stopper being in contact with the perimeter of the inlet opening.

### REFERENCE SIGNS LIST

1 Medical container
2 Liquid medicament
3 Stopper
10 Cylinder
11 Inner space
12 Inner wall
13 Inlet opening
14 Inlet end
15 Bottom end
16 Outer wall
17 Tubular outlet
30 Stopper body
31 Sealing surface
32 Annular gap
33 Actuating surface
34 Inner surface
35 Cavity
36 Hollow section
37 Circumferential ridge
38 Piercing area
4 Ambient exterior
131 Inlet section
132 Perimeter surface
141 Flange
142 Finger grip
311 Deformable sealing element
350 Cavity opening
35 Cavity base
352 Helical thread
353 Broad cavity
354 Stopper extension rod
355 Impact surface
356 Drug upper surface
357 Bypass of air
361 Hollow section base
37 Contact surface
d Transverse diameter
D Outer diameter of the stopper
F Outer diameter of the flange
X Longitudinal axis

1. A medical container for storing a liquid medicament, the medical container comprising:
a cylinder extending along a longitudinal axis, the cylinder having an inner wall, an inlet opening at an inlet end and a bottom end opposite the inlet end, which inlet opening defines a transverse diameter,
a stopper inserted into the cylinder from via the inlet opening, the stopper having a stopper body and a sealing surface surrounding the stopper body and having an outer diameter, which is larger than the transverse diameter, so that the sealing surface seals an annular gap between the inner wall and the stopper body when the stopper is inserted into the cylinder the stopper being made from a thermoplastic elastomer having a glass transition temperature (T_{g}), and the stopper having been exposed to a temperature below the glass transition temperature (T_{g}) of the thermoplastic elastomer, and
a liquid medicament in the cylinder between the bottom end and the stopper.

2. The medical container according to claim 1, wherein the stopper has a stopper body having a diameter smaller than the transverse diameter and a convex deformable sealing element having a diameter larger than the transverse diameter so that the deformable sealing element provides the sealing surface.

3. The medical container according to claim 1, wherein the thermoplastic elastomer comprises a styrene block copolymer, a polyolefin, and an oil.

4. The medical container according to claim 1, wherein the thermoplastic elastomer does not comprise a slip agent.

5. The medical container according to claim 1, wherein the stopper has been sterilised using gamma irradiation at a dose in the range of 25 kGy to 45 kGy prior to inserting the stopper into the medical container.

6. The medical container according to claim 1, wherein the thermoplastic elastomer does not comprise a perfluorinated compound.

7. The medical container according to claim 1, wherein the outer diameter is 0.5% to 10% larger than the transverse diameter.

8. The medical container according to claim 1, wherein the cylinder is made from glass or a polymer.

9. The medical container according to claim 1, wherein the thermoplastic elastomer TPE does not contain pigments or dyes.

10. The medical container according to claim 2, wherein the medical container is a prefilled syringe, and the bottom end has a tubular outlet.

11. The medical container according to claim 1, wherein the medical container is a vial.

12. The medical container according to claim 11, wherein the thermoplastic elastomer has a Shore A hardness in the range of 50 to 75.

13. The medical container according to claim 11, wherein the stopper has an actuating surface facing the ambient exterior of the medical container, and the stopper includes a cavity extending from a stopper cavity opening in the actuating surface to a stopper cavity base.

14. The medical container according to claim 12, wherein the stopper has a piercing area configured to be pierced with a hypodermic needle, the piercing area having a thickness in the range of 0.3 mm to 3 mm.

15. The medical container according to claim 1, wherein the stopper is prepared from solidifying the thermoplastic elastomer from a molten form.

16. The medical container according to claim 1, wherein the stopper is injection moulded from the thermoplastic elastomer.

17. A secondary packaging containing a medical container according to claim 1, which secondary packaging encloses the medical container and has been irradiated at a dose in the range of 0.1 kGy to 10 kGy.

18. A method of manufacturing a medical container, the method comprising the steps of:
providing a cylinder extending along a longitudinal axis, the cylinder having an inner wall, an inlet opening at an inlet end and a bottom end opposite the inlet end, which inlet opening defines a transverse diameter, which cylinder is made from glass or a polymeric material;
applying a liquid medicament in the cylinder medical container;
providing a stopper made from a thermoplastic elastomer having a glass transition temperature (T_{g})
inserting the stopper in the inlet opening to provide a filled medical container; and
lowering the temperature of the filled medical container to a temperature below the glass transition temperature (T_{g}) of the thermoplastic elastomer of the stopper.

19. The method according to claim 18 further comprising the step of increasing the temperature of the filled medical container from the glass transition temperature (T_{g}) of the thermoplastic elastomer of the stopper to ambient temperature.

20. The method according to claim 18, wherein the method further comprises the step of sterilising at least one of the cylinder and the stopper with nitrogen dioxide (NO₂).

21. The method according to claim 18, wherein the stopper has an actuating surface facing an ambient exterior of the medical container, which stopper includes a cavity extending from a stopper cavity opening in the actuating surface to a stopper cavity base, and a convex deformable sealing element having a diameter larger than the transverse diameter, wherein the method further comprises the steps of:
providing a stopper extension rod having a total length of at least 5% more than the total cavity length, and an impact surface,
inserting the stopper extension rod in the cavity of the stopper and impacting the cavity base with the impact surface at a velocity of at least 25 mm/min to extend the stopper along a cylinder longitudinal axis and cause a contraction of the deformable sealing element to create a bypass of air in the space between the stopper and the drug upper surface; and
maintaining the velocity of the stopper extension rod to move the stopper to a final stopper position.

22. (canceled)
